(19) United States
(12) Patent Application Publication
(10) Pub. No.: US 2008/0020484 A1
(43) Pub. Date: Jan. 24, 2008

(54) Methods of predicting response to a treatment for a disease

(75) Inventor: Chulso Moon, Lutherville, MD (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: Cangen Biotechnologies, Inc., Bethesda, MD (US)

(21) Appl. No.: 11/730,020

(22) Filed: Mar. 29, 2007

Related U.S. Application Data
(60) Provisional application No. 60/786,839, filed on Mar. 29, 2006.

(51) Int. Cl. G01N 24/00

(52) U.S. Cl. 436/173

(57) ABSTRACT

The present invention relates to an apparatus and methods of testing and predicting a patient's response to a treatment for a disease. In one embodiment, the present invention relates to an apparatus and methods of testing and predicting a patient's chemosensitivity before the patient begins chemotherapy. The invention may include the steps of generating mass spectra data from samples taken from a population that responds to a treatment of a disease, generating mass spectra data from samples taken from a population that does not respond to the same treatment of the disease, and comparing the two sets of data. The presence or non-presence of a peak in the compared data may be markers indicating the likelihood of response to the treatment of the disease.

### RELATED U.S. APPLICATIONS

This application claims the benefit of U.S. provisional Application No. 60/786,839, filed Mar. 29, 2006 and entitled “Methods of Predicting Responses in Disease Treatment Regimes.” The foregoing application is hereby incorporated herein by reference.

### FIELD OF THE INVENTION

The present invention relates to methods of predicting response to disease treatment regimes. More specifically, the present invention relates to methods of using mass spectra data in order to predict the response of a human to a treatment for a disease.

### BACKGROUND OF THE INVENTION

Cancer is one of the leading causes of death in the industrialized countries. One of the most deadly types of cancer is lung cancer, with the chances of a patient surviving for five-years being approximately 14%. Head and neck cancer, or head and neck squamous cell carcinoma (“HNSCC”), is also a major problem, with more than 500,000 cases diagnosed each year. Additionally, thousands of individuals are diagnosed each year with other types of cancer including, but not limited to, oral cancer, kidney cancer, bladder cancer, pancreatic cancer, esophageal cancer and pharyngeal cancer. As such, scientists are continually researching and working on improving diagnostic and therapeutic methods for detecting and treating cancer. However, despite these efforts, the overall survival rate (measured five years after diagnosis) of cancer patients remains low.

The low overall survival rate of cancer patients is due largely to the difficulty in diagnosing cancer in its early stages and achieving a sustainable treatment response. Patients having cancer in advanced stages and those with recurrent disease are candidates for systematic therapy, usually in the form of chemotherapy. At present, medical oncologists prescribe cancer chemotherapy according to fixed schedules called protocols.

The same, or similar, protocols are often prescribed for all patients suffering from a particular type of cancer, despite the fact that different patients may respond in different ways to the various types of available chemotherapy and protocols. For example, it has been shown (after treatment) that lung cancer patients that were given combinations of chemotherapy, to which they respond most favorably, have a survival rate higher than patients who are given a combination of chemotherapy treatments which includes treatments to which they do not respond. However, it is difficult to determine before treatment begins whether a patient will respond favorably to a particular type of chemotherapy.

The difficulty in predicting whether a patient will respond favorably to a particular type of chemotherapy is one of the reasons that the cost of treating cancer is so high. In the United States, for example, a patient's cost of treating cancer may be approximately $50,000, and may rise to as much as $200,000 or more. The total cost to the health care industry is estimated to be between $30 billion and $40 billion per year. Furthermore, because some patients may be subjected to protocols which include chemotherapy treatments to which they do not respond, they may unnecessarily suffer from side effects due to the toxicity of the treatments.

One attempt at predicting a cancer patient's response to a particular disease is known as cell culture drug resistance testing (“CCDRT”). CCDRT may be used to test a patient's own cancer cells in a laboratory with drugs that may be used to treat the patient's cancer. While CCDRT may improve a patient's probability of benefiting from treatment, CCDRT is not without its problems. For example, a surgical specimen is required and, because patients may not present the cancer until they are in its advanced stages, it may be difficult to obtain the required specimen before it is desirable to begin treatment. Furthermore, obtaining a surgical specimen may require invasive surgery which may be detrimental to the health of the patient.

Based on the foregoing, there is a clear need for an improved method of predicting the manner in which a patient may respond to a particular type of chemotherapy for treating a particular type of cancer.

### SUMMARY OF THE INVENTION

The present invention relates to methods of predicting response to disease treatment regimes. More specifically, the present invention relates to methods of using mass spectra data in order to predict the response of a human to a treatment for a disease.

The present invention may include a method of predicting response to a treatment for a disease. The method may comprise the steps of generating a first set of mass spectra data from biological samples taken from a population that respond to a treatment for a disease, generating a second set of mass spectra data from biological samples taken from a population that does not respond to the same treatment for the disease and comparing corresponding peaks in the first and second sets of mass spectra data, wherein a difference in corresponding peaks represents at least one marker indicating the likelihood that a patient will respond to the treatment for the disease.

These and other objects and advantages of the invention will be apparent from the following description, the accompanying drawings and the appended claims.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 shows an apparatus according to one embodiment of the present invention.

FIG. 2A shows a method according to one embodiment of the present invention.

FIG. 2B shows another method according to one embodiment of the present invention.

FIGS. 3A-3G are mass spectra generated from sera of responders to a disease treatment according to one embodiment of the present invention.

FIGS. 3H-3Q are mass spectra generated from sera of non-responders to a disease treatment according to one embodiment of the present invention.

### DETAILED DESCRIPTION OF THE INVENTION

The present disclosure will now be described more fully with reference to the Figures in which various embodiments of the present invention are shown. The subject matter of this disclosure may, however, be embodied in many different forms and should not be construed as being limited to the embodiments set forth herein.

A method for predicting a patient's response to a treatment for a disease is described. While, for simplicity and illustrative purposes, the principles of the present invention are described by referring to specific types of cancers or samples with respect to humans, one of ordinary skill in the art will realize that this is not intended to be limiting. Thus, one of ordinary skill in the art will realize that the present invention may be utilized for predicting a patient's response to a treatment for a disease for a variety of common types of diseases by analyzing a variety of common types of samples taken from a variety of organisms.

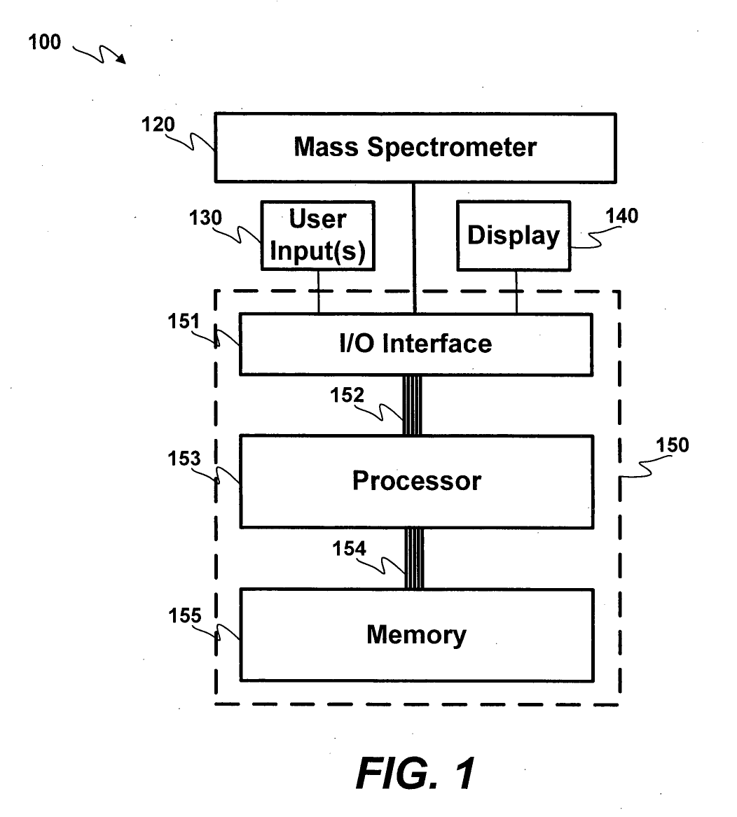

FIG. 1 shows an apparatus 100 according to one embodiment of the present invention. As illustrated in FIG. 1, one embodiment of the present invention may include a mass spectrometer 120. As will be apparent to one of ordinary skill in the art, the mass spectrometer 120 may be used for measuring the mass-to-charge ratio of ions in a sample. The mass spectrometer 120 may ionize the sample and may first separate ions in the sample having differing masses and then may record each ion's relative abundance in the sample by measuring the intensities of ion flux. The results of the mass spectrometry may then be produced in a mass spectrum, which may be represented in a figure that looks like a chromatogram or spectrogram.

It is contemplated that any type of mass spectrometer may be utilized with the present invention including, but not limited to, spectrometers that utilize sector, time-of-flight (“TOF”), quadrupole, quadrupole ion trap, linear quadrupole ion trap, fourier transform ion cyclotron resonance, liquid chromatography/mass spec/mass spec (“LC/MS/MS”) or orbitrap mass analysis. Furthermore, any type of mass spectrometry technique may be utilized by the present invention provided the technique is within the scope and spirit of the present invention. This may include the use of any well known mass spectrometry technique including, but not limited to, matrix-assisted laser desorption/ionization (“MALDI”), electrospray ionization (“ESI”) or LC/MS/MS.

As further illustrated in FIG. 1, the present invention may also include a processor-based system 150, user inputs 130 and a display 140. In one embodiment, the processor-based system 150 may include an input/output (“I/O”) interface 151, through which the mass spectrometer 120 may be connected to the processor-based system 150. In alternative embodiments, various I/O interfaces may be used as I/O interface 151 as long as the functionality of the present invention is retained.

According to one embodiment of the present invention, the processor-based system 150 may be used to control the mass spectrometer 120. However, it is contemplated that a separate processor based system may also be used to control the mass spectrometer 120, including a processor-based system incorporated into the mass spectrometer 120. Further, the results produced by the mass spectrometer 120 may be passed to the processor-based system 150 for processing, as discussed in detail below. While a direct connection between the mass spectrometer 120 and the processor-based system 150 is illustrated in FIG. 1, it is also contemplated that the results may be passed to the processor-based 150 system through a network (including, but not limited to, a local or a public network) or that the results may be passed through an additional peripheral device (not shown) such as an amplifier. Additionally, it is contemplated that the results may be saved to a storage medium, such as a floppy disk or CD-ROM and transferred to the processor-based system 150.

The I/O interface 151 may also be coupled to one or more input devices 130 including, but not limited to, user input devices such as a computer mouse, a keyboard, a touch-screen, a track-ball, a microphone (for a processor-based system having speech recognition capabilities), a bar-code or other type of scanner, or any of a number of other input devices capable of permitting input to be entered into the processor-based system 150.

Additionally, the I/O interface 151 may be coupled to at least one display 140 for displaying information to a user of the processor-based system 150. Numerous types of displays may be used in connection with the present invention depending on the type of information to be displayed. In one embodiment, display 140 may be a monitor, such as an LCD display or a cathode ray tube (“CRT”). Alternatively, the display may be a touch-screen display, an electroluminescent display or any other display that may be configured to display information to a user of processor-based system 150. It should also be realized that the mass spectrometer 120 may utilize display 140 or it may include its own display.

The I/O interface 151 may be coupled to a processor 153 via a bus 152. The processor 153 may be any type of processor configured to execute one or more application programs, for example. As used herein, the term application program is intended to have its broadest meaning and should include any type of software. Moreover, numerous applications are possible and the present invention is not intended to be limited by the type of application programs being executed or run by processor 153.

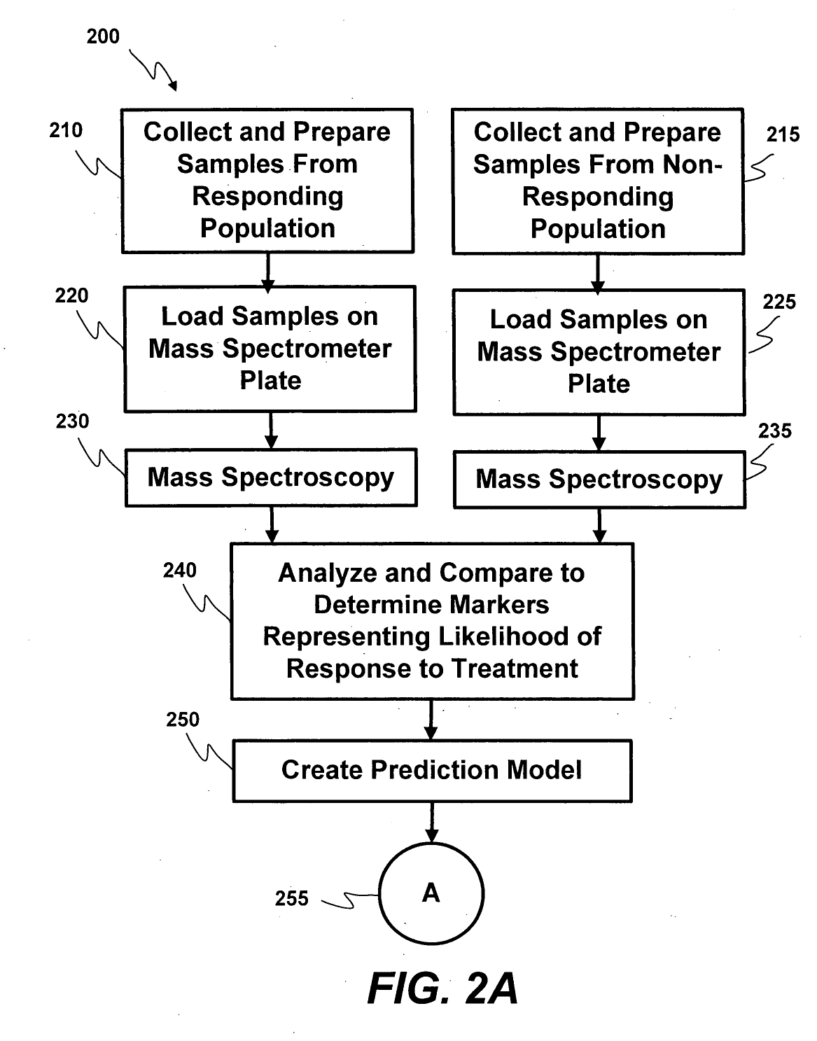

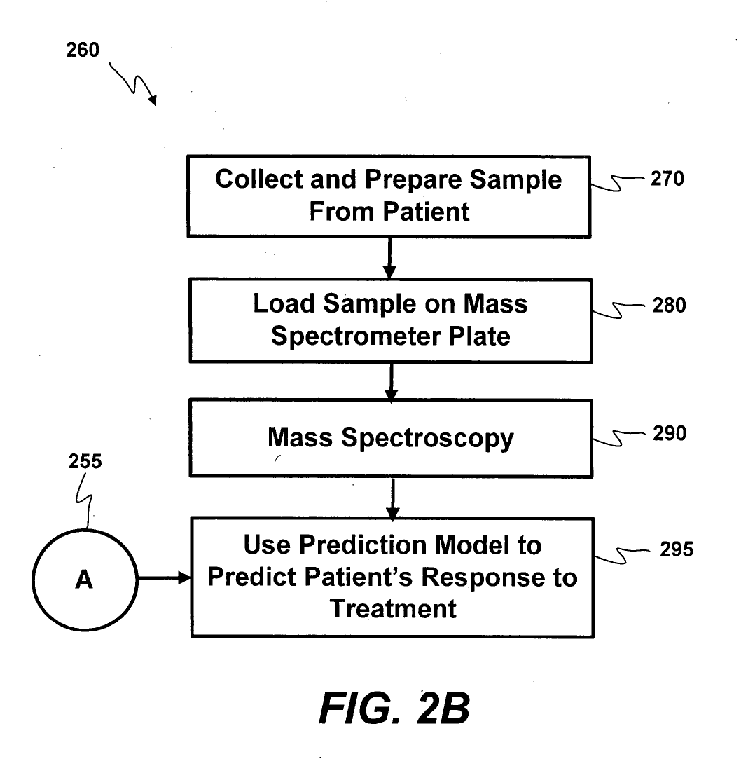

Further, processor 153 may be coupled to a memory 155 via a bus 154. Memory 155 may be any type of a memory device including, but not limited to, volatile or non-volatile processor-readable media such as any magnetic, solid-state or optical storage media. Processor 153 may be configured to execute software code stored on memory 155 including software code for performing the functions of the processor 153. According to one embodiment of the present invention, memory 155 includes software code, which may be read by the processor, for instructing the processor 153 to execute the methods according to the present invention discussed in detail below with reference to FIGS. 2A and 2B.

FIGS. 2A and 2B show a method of predicting a patient's response to a treatment for a disease according to one embodiment of the present invention. As illustrated in FIG. 2A, the present invention may include a method 200 for creating a prediction model, which may be used in the prediction of a patient's response to a specific treatment for a specific type of disease, as discussed below. While specific examples of the present invention discussed below may reference the prediction of response to specific treatments and specific diseases, it should be realized that the present invention is not meant to be limited to any particular treatment or any particular disease. In fact, the present invention is applicable to any treatment for a disease including, but not limited to, any type of chemotherapy, the administration of drugs, surgery or any other pharmacological manipulation of a patient's physiological systems. Further, the present invention is applicable to any disease that may show a difference in the detection of specific mass-ion peaks in mass spectra of patients responding or not responding to treatments for the disease compared to those of normal patients. Exemplary diseases may include, but are not limited to, cancers of the respiratory, gastrointestinal, renal, CNS, endocrine and blood systems or any other diseases or disease processes (e.g. necrosis, apoptosis) in which there are potential alterations in molecules contained in biological fluid (e.g. blood and blood derivatives, urine, cerebral spinal fluid, sputum, lavage). Such biological molecules may include, but are not limited to, macromolecules such as polypeptides, proteins, nucleic acids, enzymes, DNA, RNA, polynucleotides, oligonucleotides, carbohydrates, oligosaccharides, polysaccharides, fragments of biological macromolecules (e.g. nucleic acid fragments, peptide fragments, and protein fragments), complexes of biological macromolecules (e.g. nucleic acid complexes, protein-DNA complexes, receptor-ligand complexes, enzyme-substrate, enzyme inhibitors, peptide complexes, protein complexes, carbohydrate complexes, and polysaccharide complexes), small biological molecules such as amino acids, nucleotides, nucleosides, sugars, steroids, lipids, metal ions, drugs, hormones, amides, amines, carboxylic acids, vitamins and coenzymes, alcohols, aldehydes, ketones, fatty acids, porphyrins, carotenoids, plant growth regulators, phosphate esters and nucleoside diphospho-sugars, synthetic small molecules such as pharmaceutically or therapeutically effective agents, monomers, peptide analogs, steroid analogs, inhibitors, mutagens, carcinogens, antimitotic drugs, antibiotics, ionophores, antimetabolites, amino acid analogs, antibacterial agents, transport inhibitors, surface-active agents (surfactants), mitochondrial and chloroplast function inhibitors, electron donors, carriers and acceptors, synthetic substrates for proteases, substrates for phosphatases, substrates for esterases and lipases and protein modification reagents; and synthetic polymers, oligomers, and copolymers. Additionally, any suitable mixture or combination of the substances mentioned above may also be included in the biological samples.

As shown in FIG. 2A at step 210, biological samples may be collected and prepared for mass spectrometry from a population of individuals who are responding, or have responded to, a particular treatment for a particular disease. Likewise, at step 215, biological samples may be collected and prepared for mass spectrometry from a population of individuals who are not responding, or did not respond to the same treatment for the same disease. Any type of biological sample may be used including, but not limited to, soft and hard tissue (e.g., from biopsies), blood, serum, plasma, nipple aspirate, urine, tears, saliva, cells, organs, semen, feces, and the like. The population may include any number of individual organisms and a sample may be collected from each individual in the population. One of ordinary skill in the art will realize that the size of the population used for the creation of the prediction model may be dependent upon the desired accuracy of the prediction model.

While the examples discussed below reference samples taken from human beings, it is contemplated that the present invention may be utilized for the prediction of response to a treatment for a disease in any type of organism including, but not limited to, eukaryotic, prokaryotic, or viral organisms. The collection of the samples may be performed using any conventional methods for extracting biological samples from these organisms, as will be known to one of ordinary skill in the art.

It should be noted that the type of samples used for the prediction of response to a specific treatment for a specific disease may be dependent on the type of treatment and disease for which a prediction model is to be created. For example, if it is desired to create a prediction model for the prediction of response to a chemotherapy treatment for bladder cancer in humans, it may be desirable to collect urine samples from a number of humans known to respond to that particular chemotherapy treatment at step 210 and to collect urine samples from a number of humans known not to respond to that particular treatment at step 215.

Once the samples have been collected, they may be prepared for mass spectrometry using any conventional method for preparation including, but not limited to, filtration, extraction, centrifugation, purification, ion-exchange or size chromatography, precipitation, buffer exchange or dilution. The samples may then be prepared for evaluation by a mass spectrometer by making a matrix of samples. An appropriate matrix may be chosen according to the appropriate mass/ion species of interest. At steps 220 and 225, the matrix and the samples may then be loaded onto a mass spectrometer plate associated with the mass spectrometer to be used for the analysis.

Each set of samples may then be placed in a mass spectrometer at steps 230 and 235. While it is contemplated that any conventional type of mass spectrometer may be utilized, as discussed above, one embodiment of the present invention utilizes matrix-assisted laser desorption/ionization—time of flight (“MALDI-TOF”) mass spectrometer. As known to one of ordinary skill in the art, MALDI-TOF is a mass spectrometry technique in which a co-precipitate of an ultraviolet light absorbing matrix and a biomolecule may be irradiated by a nanosecond laser pulse. Most of the laser energy may be absorbed by the matrix, which may prevent unwanted fragmentation of the biomolecule. The spectrometer may operate on the principle that when a temporally and spatially well defined group of ions of differing mass/charge (m/z) ratios are subjected to the same applied electric field and allowed to drift in a region of constant electric field, they may traverse this region in a time which depends upon their m/z ratios. The ionized biomolecules in the sample may then be accelerated in an electric field and enter the flight tube (under vacuum) of the spectrometer.

During the flight in this tube, the different molecules of the sample may be separated according to their mass to charge ratio and may reach the detector of the spectrometer at different times. Again, the time an ion takes to pass down the tube depends on the ratio of its charge to its mass—its mass/charge ratio, m/z. The spectrometer may observe the time of flight of the ion as it travels from anode or cathode to detector.

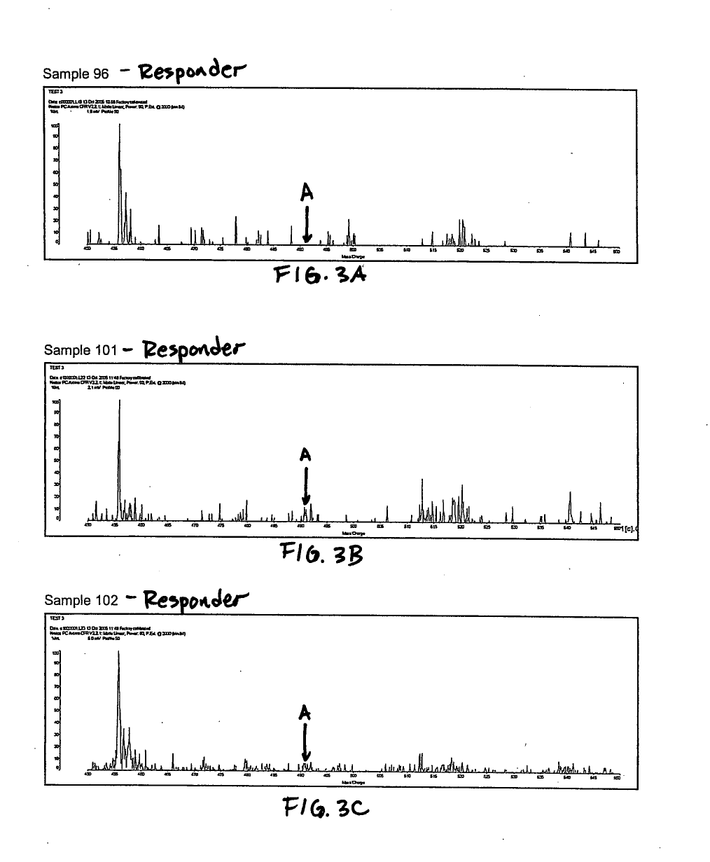

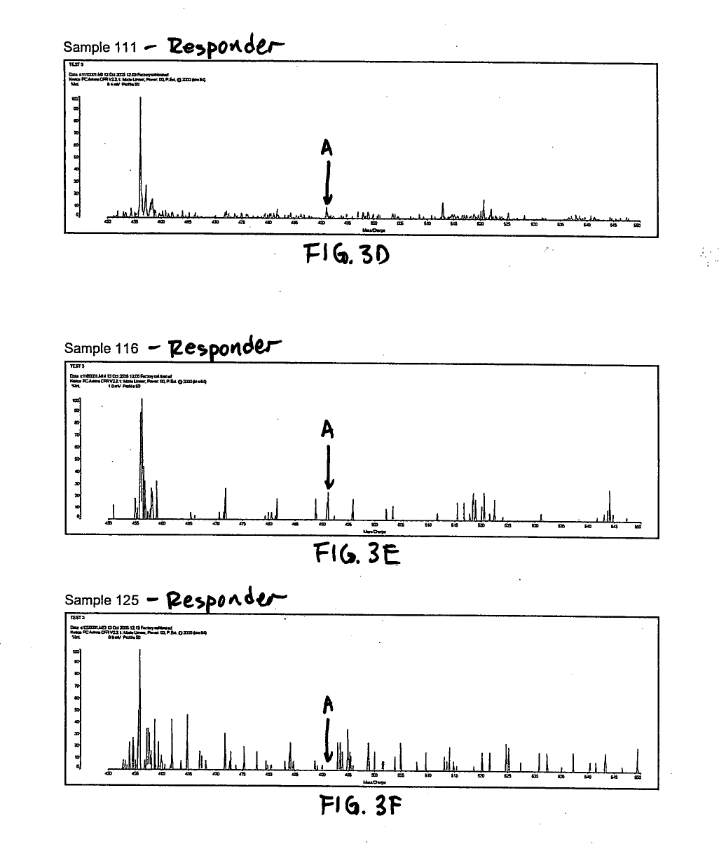

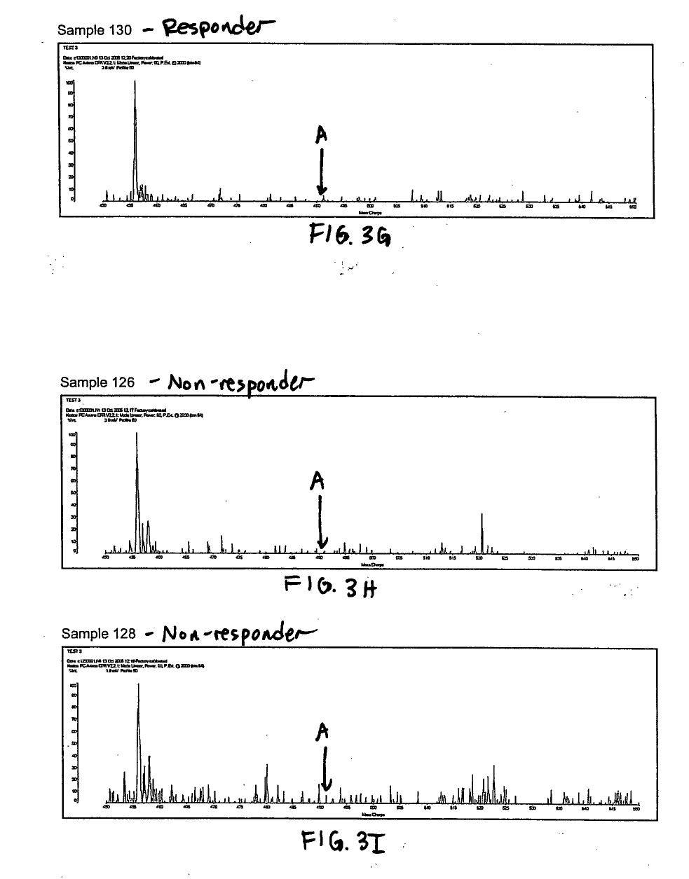

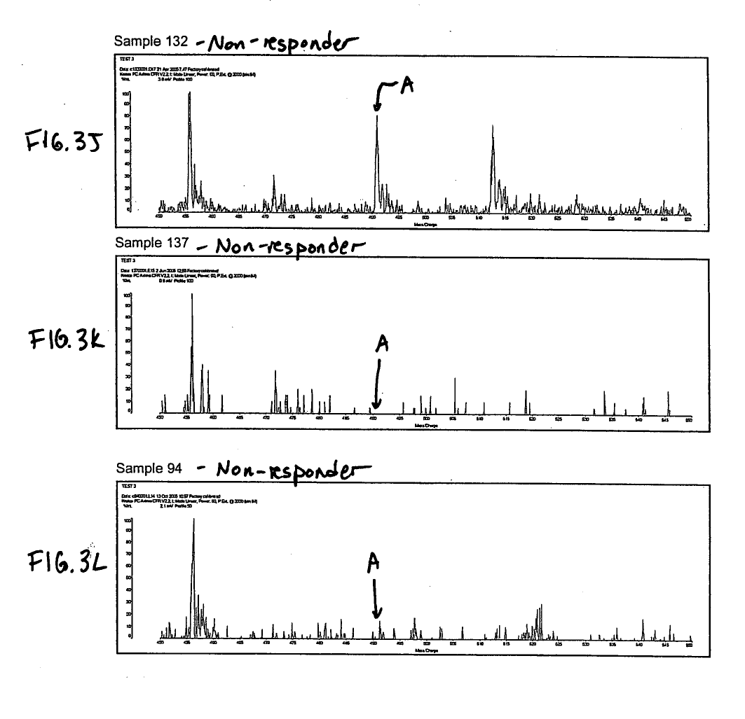

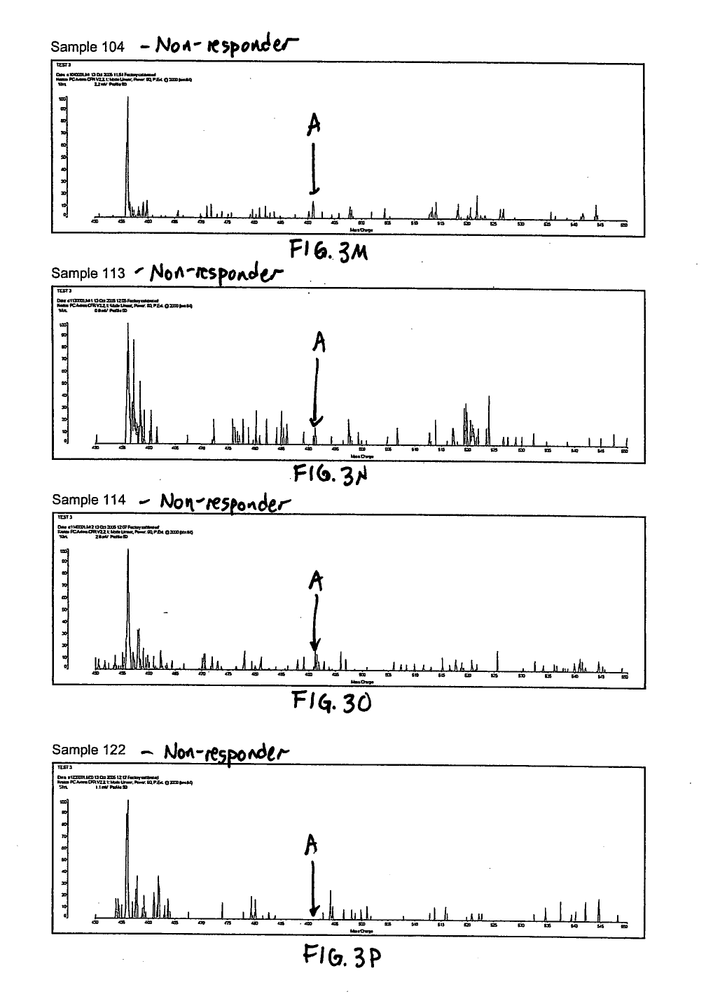

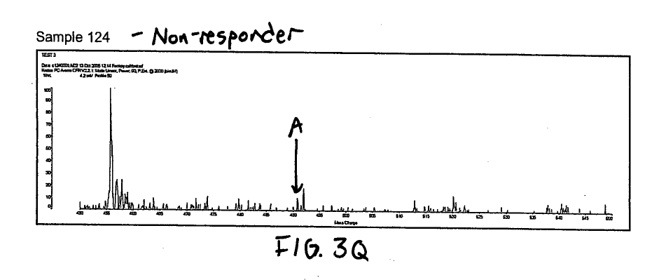

Generally, the spectrometer's software may convert the time of flight of the ion to an m/z ratio. The spectrometer may then output the number of ions in the sample having this m/z ratio. While, for clarity, FIGS. 3A-3Q of the present invention illustrate the output of the spectrometer as a mass spectrum showing the number of ions in a sample having a specific m/z ratio, it is contemplated that any type of output may be provided by the spectrometer. This may include the output of “raw data” to processor-based system 150, a spectrograph, a spreadsheet or any other conventional types of data output.

Once mass spectrometry of the samples is completed (steps 230 and 235), the processor-based system 150 may then receive the results at step 240 for analysis and comparison. In one embodiment of the present invention, processor-based system 150 may utilize a spreadsheet or other commonly known statistical package including, but not limited to, SAS or SPSS for analyzing the data. As discussed in detail below, a prediction model may then be created (step 250) which may then be stored in memory and accessed for use in the prediction of a patient's response to a treatment for a disease (step 255).

The analysis and comparison of the spectrometry data at step 240 may be performed by identifying a number of optimal features in the data and performing a statistical analysis to identify a predictor in the spectrometry data which may be used for the prediction of a patient's response to the particular treatment for a disease being analyzed, and as illustrated in the examples below. As will be known to one of ordinary skill in the art, the present invention may utilize any appropriate statistical analysis including, but not limited to, linear discriminant analysis (including Fisher's linear discriminant analysis), variance analysis, regression analysis, principal component analysis, factor analysis or discriminant correspondence analysis. In one embodiment, feature extraction may be performed prior to the statistical analysis in order to further select top spectral weight values.

According to one embodiment of the present invention, linear discriminant analysis (“LDA”) may be performed in any conventional manner for applying LDA to data output from a mass spectrometer, as known to one of ordinary skill in the art. This may include first generating a model having one or more estimated parameter values associated with a conditional distribution of the data from the samples collected and prepared at step 210. It should be noted that in the model, predictor or covariate values may identify spectral weight values associated with a patient's response to the treatment for the disease. The estimated parameter values may also be modified by identifying one or more true positives and false positives among them, as will be known to one of ordinary skill in the art.

The data from the samples collected and prepared at step 215 may then be compared to the model to determine which estimated parameter may be the predictor spectral weight value associated with a response, or non-response, to the treatment for the disease. This may be accomplished by determining which peaks are present in the samples collected and prepared at step 215 and not present in the samples collected and prepared at step 210, or vice versa. Based on the results of the linear discriminant analysis, a prediction model may be created at step 250 which may identify which spectral weight values are associated with a response, or non-response, to a specific treatment for a specific disease.

For example, and as discussed below in the Examples, the statistical analysis may identify that a particular spectral peak in the spectrometry data of a patient who responds to a specific treatment for a specific disease may not be present in the spectrometry data of a patient who does not respond to the treatment. Thus, the method of the present invention described with reference to FIG. 2A may be used to identify the specific spectral peak or peaks which are not present in a patient who does not, or will not, respond to a particular treatment for a particular disease. As such, the prediction model may be used to look at the spectrometry data of a patient to look for the presence, or non-presence, of that particular spectral peak to determine whether the patient may respond to the particular treatment for the particular disease.

In one embodiment of the present invention, it may be desirable to test the prediction model before it is used to predict responses to treatment of disease in patients. This process may involve utilizing the steps described below with reference to FIG. 2B by using a sample from a patient known to respond to, or known not to respond to, the particular treatment for the particular disease for which the prediction model is to be used. Once the prediction model is validated, it may be used to predict the responsiveness to treatment of the disease in patients, as described below with reference to FIG. 2B.

As illustrated in FIG. 2B, the present invention may include a method 260 for determining whether a patient will, or will not, respond to a particular treatment for a particular disease by using a prediction model created according to the method discussed with reference to FIG. 2A. At step 270, a biological sample may be collected from a patient in the same manner as the collection of samples from the population discussed above. It should again be noted that the type of sample and the type of patient should correspond to the type of sample and the type of organisms in the population used in the creation of the prediction model. At step 280, the sample from the patient may be loaded on the mass spectrometer plate, in the same manner as discussed above, and the mass spectrometer may be used to analyze the sample in the same manner as discussed above.

In the method 260, it may not be known whether the patient will, or will not, respond to a particular treatment for a particular disease. Thus, a prediction model 255 for that particular treatment for a particular disease, created in the manner discussed above, may be accessed at step 295 and used to determine whether the patient will respond to the particular treatment. This may involve utilizing the prediction model 255 to look for the presence or absence of a specific spectral peak or peaks in the patient's mass spectrum, which may be accomplished using any conventional method for analysis known to one of skill in the art. More particularly, this analysis may also include, but is not limited to, having a trained scientist compare the patient's mass spectra with that of the prediction model or having the comparison performed by a processor-based system. As one of ordinary skill in the art will realize, once a patient's clinical responsiveness to a particular treatment for a particular disease is predicted, this information may then be used to treat the patient for the disease using treatments to which the patient may respond. This method is illustrated in further detail with respect to the Examples discussed below.

As mentioned above, the following Examples 1 and 2 illustrate specific testing and analysis of sera using the methods of the present invention. One of ordinary skill in the art will realize that, while each of these examples is specific to a particular treatment for a particular disease and testing situation, they are only being provided for illustrative purposes and are not meant to limit the scope and applicability of the present invention.

### EXAMPLE 1

The discussion below describes a specific screening for chemosensitivity of patients having lung cancer performed using the apparatus and methods according to the present invention discussed above. Initially, sera were collected from (a) 65 patients without a history of cancer (healthy controls) and (b) 140 patients with histologically confirmed lung cancer. Of the 140 patients having lung cancer, 98 represented patients who had at least one chemotherapy combination treatment (among the twenty-three different available chemotherapy combinations for lung cancer). Overall, 32.7% of these patients had responded to treatment and 67.3% had no response to their treatment. The table below sets forth the number of samples representing patients who received a particular chemotherapy combination and the number of patients who responded or did not respond to that combination. It should be noted that one patient may have been treated with more than one treatment.

| Chemotherapy | Total No. of | No. of | No. of Non- |
|---|---|---|---|
| Treatment Type | Samples | Responders | Responders |
| Taxol-based Chemotherapy | 53 | 14 | 39 |
| Gemzar-based Chemotherapy | 40 | 10 | 30 |
| Non-Taxol-based and Non- | 44 | 16 | 28 |
| Gemzar-based Chemotherapy | | | |

Each sample was then prepared for evaluation by the mass spectrometer by making a matrix of serum samples. The mass spectrometer matrix contained saturated alpha-cyano-4-hydroxycinnamic acid in 50% acetonitrile-0.05% trifluoroacetic acid (TFA). The sera were diluted 1:1000 in 0.1% n-Octyl β-D-Glucopyranoside. 0.5 μL of the matrix was placed on each defined area of a sample plate with 384 defined areas and 0.5 μL serum from each individual was added to a defined area followed by air drying. Samples and their locations on the sample plates were recorded for accurate data interpretation. An Axima-CFR MALDI-TOF mass spectrometer manufactured by Kratos Analytical Inc. was used. The instrument was set to the following specifications: tuner mode, linear; mass range, 0 to about 5,000; laser power, 90; profile, 100; and shots per spot, 5. The output of the mass spectrometer was stored in computer storage in the form of a sample data set.

From analysis of the sample data set, a peak was identified at a mass/charge ratio of 491 which correlated with the “No Response to Taxol-based Chemotherapy” group. This peak was present in a large number of patients that did not respond to Taxol-based chemotherapy. In the United States, approximately 100,000 cases of Taxol-based chemotherapy are administered each year with an approximate overall cost of $100,000 per case. However, some of these patients do not respond to the treatment, as discussed above. If the present invention were utilized prior to the administration of the treatment, approximately $100,000 per non-responding patient may be saved because Taxol-based chemotherapy may not unnecessarily be prescribed. Thus, for a lung cancer patient for whom Taxol-based chemotherapy is being considered, their mass spectra data should be analyzed for a peak at a mass/charge ratio of 491 and, if peak 491 appears in a mass spectrum of a patient, it may be concluded that they may not respond to the treatment, and other treatment should be considered.

Additionally, one of ordinary skill in the art will realize that the present invention may be utilized for determining other mass/ion peaks which may be correlated with a resistance (or lack of response) to other combinations of chemotherapy. This may include, but is not limited to, determining mass/ion peaks which may be correlated with Gemzar-based chemotherapy or Non-gemzar, Non-Taxol-Platinum-based chemotherapy.

### EXAMPLE 2

The discussion below describes another specific screening of lung cancer patients for response to Taxol-based chemotherapy. MALDI-TOF was used to generate a spectra sample data set representing distinct m/z ion peak distribution patterns in serum. Linear discrimination analysis was then used to create a prediction model, as discussed below.

The sera were prepared for evaluation by the mass spectrometer by making a matrix of serum samples. The mass spectrometer matrix contained saturated alpha-cyano-4-hydroxycinnamic acid in 50% acetonitrile-0.05% trifluoroacetic acid (TFA). The sera were diluted 1:1000 in 0.1% n-Octyl β-D-Glucopyranoside. 0.5 μL of the matrix was placed on each defined area of a sample plate with 384 defined areas and 0.5 μL serum from each individual was added to a defined area followed by air drying. Samples and their locations on the sample plates were recorded for accurate data interpretation. An Axima-CFR MALDI-TOF mass spectrometer manufactured by Kratos Analytical Inc. was used. The instrument was set to the following specifications: tuner mode, linear; mass range, 0 to about 5,000; laser power, 90; profile, 100; and shots per spot, 5. The output of the mass spectrometer was stored in computer storage in the form of a sample data set.

FIGS. 3A to 3Q illustrate the spectra data used in the present Example. FIGS. 3A to 3G are mass spectra of patients that showed response to Taxol-based chemotherapy. FIGS. 3H to 3Q are mass spectra of patients showing no response to Taxol-based chemotherapy. Analysis of the mass spectra reveals that a peak is present at a particular point A in a substantial number (for example, FIG. 3J) of non-responders that is not present in the responders. As shown in the figures, point A corresponds to a mass over charge ratio of 491. In the present example, the presence of a peak at point A illustrates a patient's non-response to Taxol-based chemotherapy. Therefore, it can be concluded, using the method of the present invention, that patients whose mass spectra illustrates a peak at point A may be predicted to be a non-responder to Taxol-based chemotherapy.

As one of ordinary skill in the art will realize, the present invention has many advantages and benefits over the methods currently used for determining what treatments to prescribe for different diseases. For example, the present invention may improve patient survival by allowing practitioners to select appropriate, individualized treatment regimens when a disease is first diagnosed. Additionally, and specifically with respect to chemotherapy, the present invention may reduce patient exposure to toxic treatment regimens by eliminating unnecessary and ineffective treatment regimens. Further, the present invention may be used to better characterize the activity of therapeutic compounds during development. Finally, the present invention may assist drug developers and practitioners in identifying patient population segments with the greatest likelihood of response to certain investigational therapies, thereby increasing patient accruals to clinical trials.

While the invention has been described with reference to certain exemplary embodiments thereof, those skilled in the art may make various modifications to the described embodiments of the invention without departing from the scope of the invention. The terms and descriptions used herein are set forth by way of illustration only and are not meant as limitations. In particular, although the present invention has been described by way of examples, a variety of compositions and methods would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

The foregoing descriptions of specific embodiments of the present invention are presented for purposes of illustration and description. They are not intended to be exhaustive or to limit the invention to the precise forms disclosed. Obviously, many modifications and variations are possible in view of the above teachings. While the embodiments were chosen and described in order to best explain the principles of the invention and its practical applications, thereby enabling others skilled in the art to best utilize the invention, various embodiments with various modifications as are suited to the particular use are also possible. The scope of the invention is to be defined only by the claims appended hereto, and by their equivalents.

What is claimed is:

1. A method of predicting response to a treatment for a disease, the method comprising the step of:
generating a first set of mass spectra data from biological samples taken from a population that respond to a treatment for a disease;
generating a second set of mass spectra data from biological samples taken from a population that does not respond to the same treatment for the disease; and
comparing corresponding peaks in the first and second sets of mass spectra data, wherein a difference in corresponding peaks represents at least one marker indicating the likelihood that a patient will respond to the treatment for the disease.

2. The method according to claim 1, further comprising using the at least one marker to predict the likelihood that a patient having the disease will respond to the treatment for the disease.

3. The method according to claim 2, wherein the at least one marker is used for predicting the patient's response to a particular chemotherapy treatment before the patient begins the chemotherapy.

4. The method according to claim 1, wherein the mass spectra data are generated by Matrix Assisted Laser Desorption/Ionization (MALDI) spectrometry.

5. The method according to claim 1, wherein a difference in corresponding peaks represents the presence of at least one specific molecule whose increased or decreased level in a biological fluid taken from an individual is predictive of the individual's response to the treatment for the disease.
